(19) United States
(12) Patent Application Publication
(10) Pub. No.: US 2016/0086199 A1
(43) Pub. Date: Mar. 24, 2016

(54) System and method for performing demand response optimizations

(71) Applicant: Neurio Technology Inc., Vancouver (CA)

(72) Inventors: Keith EDMONDS, Vancouver (CA); Ali HAGHIGHAT KASHANI, Vancouver (CA); Zhenyu GUO, Vancouver (CA); Janice CHEAM, Vancouver (CA)

(73) Assignee: Neurio Technology Inc., Vancouver (CA)

(21) Appl. No.: 14/652,678

(22) PCT Filed: Apr. 3, 2014
(86) PCT No.: PCT/CA14/50335

§ 371 Date: Jun. 16, 2015

Related U.S. Application Data
(60) Provisional application No. 61/811,670, filed on Apr. 12, 2013.

(51) Int. Cl. G06Q 30/02; G06Q 50/06

(52) U.S. Cl. CPC G06Q 30/0202; G06Q 50/06

(57) ABSTRACT

A method and system are provided for optimizing a demand response program. The method comprises obtaining usage data for a plurality of target devices; and using at least one variable associated with usage behavior of the plurality of target devices to optimize the demand response program.

This application claims priority to U.S. Provisional Patent Application No. 61/811,670 filed on Apr. 12, 2013, the contents of which are incorporated herein by reference.

### TECHNICAL FIELD

The following relates to systems and methods for performing demand response optimizations.

### DESCRIPTION OF THE RELATED ART

In electricity grids, demand response (DR) mechanisms are commonly used to manage customer consumption of electricity in response to supply conditions, for example, by having electricity customers reduce their consumption at critical times or in response to market prices. DR is often used to lower peak demand in the grid. DR mechanisms respond to explicit requests to shut off or otherwise curtail power consumption, in contrast to dynamic demand devices which passively shut off when stress in the electricity grid is sensed. DR can involve specifically curtailing power that is being consumed, or by increasing on-site generation which may or may not be connected in parallel with the electricity grid.

The electricity grid has several parameters that are to be considered in implementing DR mechanisms. The nameplate or rated capacity is the intended technical full-load sustained output of a power plant or power grid. The capacity factor, is considered the ratio of a power plant's actual output over a period of time, to its potential output if it were possible for it to operate at full nameplate capacity indefinitely. The peak demand is the maximal amount of power drawn from the grid in a particular time range, the peak time is the time associated with peak demand, and critical times are known as peak times when the peak demand is close to the nameplate capacity of the grid. Direct load control (DLC) is known as a methodology which allows a utility to turn on and off specific appliances for DR.

According to the Federal Energy Regulatory Commission (FERC), DR is defined as: “Changes in electric usage by end use customers from their normal consumption patterns in response to changes in the price of electricity over time, or to incentive payments designed to induce lower electricity use at times of high wholesale market prices or when system reliability is jeopardized.”

The demand for electrical power varies considerably with time of day and time of year. Electrical generation and transmission systems are generally sized to correspond to demand plus a margin for forecasting error and unforeseen events.

While the grid infrastructure and the power supply has a hard upper limit based on the nameplate capacity, the grid needs to be able to support the maximum possible demand. The demand on a grid typically grows in time as population increases, which brings local peak times closer to the nameplate capacity if the grid is not upgraded. If a critical time is forecasted to be reached, action should be taken either through increasing capacity through capital expenditure or decreasing demand through DR.

Depending on the configuration of generation capacity, DR may also be used to increase demand (i.e. the load) at times of high production and low demand. Some systems may thereby encourage energy storage to arbitrage between periods of low and high demand. Alternatively demand which could be applied at arbitrary times with equal gain for the consumer are encouraged to apply them at off peak time.

There are multiple types of DR, which are typically implemented by the installation of power cut off devices to certain loads. At critical times the power supply to these loads would be cut or reduced to lower the total demand to the electricity grid. This process is commonly referred to as load shedding.

Residentially, load shedding is usually implemented through voluntary programs where direct load control devices are installed. Loads that can be periodically reduced or turned off completely without damage are referred to as interruptible and curtailable loads. Economic demand response is implemented by allowing utilities to control the demand of interruptible and curtailable appliances in exchange for a monetary reward. These agreements are often linked with emergency demand response as emergency demand response is less common.

Load shedding is usually considered to be costly to utilities for at least two reasons. First is the associated cost with installing demand response devices. Second, the cost for incentivising the customer to participate in such a program can be high and difficult to predict.

### BRIEF DESCRIPTION OF THE DRAWINGS

Embodiments will now be described by way of example with reference to the appended drawings wherein:

FIG. 1 is a block diagram illustrating an example of a system for performing DR optimizations;

FIG. 2 is a block diagram of an example of a configuration for a DR optimization system;

FIG. 3 is a flow diagram illustrating example computer executable operations for performing a DR optimization;

FIG. 4 is a flow diagram illustrating various types of DR;

FIG. 5 is a graph illustrating average energy readings for a particular consumer;

FIG. 6 is a flow diagram illustrating example operations performed in a DR optimization analysis;

FIG. 7 is a flow diagram illustrating an optimization between braches shown in FIG. 6;

FIG. 8 is a flow diagram illustrating a ranking process;

FIG. 9 is a chart illustrating an percent error comparison;

FIG. 10 is a graph illustrating peak demand potential;

FIG. 11 is a graph illustrating a diversification curve;

FIG. 12 is a graph illustrating a load demand with respect to temperature;

FIG. 13 is a graph illustrating total grid power demand versus number of participants for a number of DR program types;

FIG. 14 is a graph illustrating appliance consumption versus temperature for a selection of users;

FIG. 15 is a graph illustrating energy demand for the selection of users; and

FIG. 16 is a screen shot of an example of a visual representation of homes responding to a DR event.

### SUMMARY

There is provided a method of optimizing a demand response program, the method comprising: obtaining usage data for a plurality of target devices; and using at least one variable associated with usage behavior of the plurality of target devices to optimize the demand response program.

There is also provided a system and computer readable medium for performing the above method.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It has been recognized that since the installation of DR equipment and the need to provide incentives for subscribers are expensive for utilities wanting to implement DR mechanisms and programs, savings can be made by targeting specific users for DR programs. The following provides systems and methods for perform DR analyses in order to enable utilities to intelligently determine which users are more likely to provide an impact due to a higher likelihood of participation and a higher likelihood of that participation having such an impact.

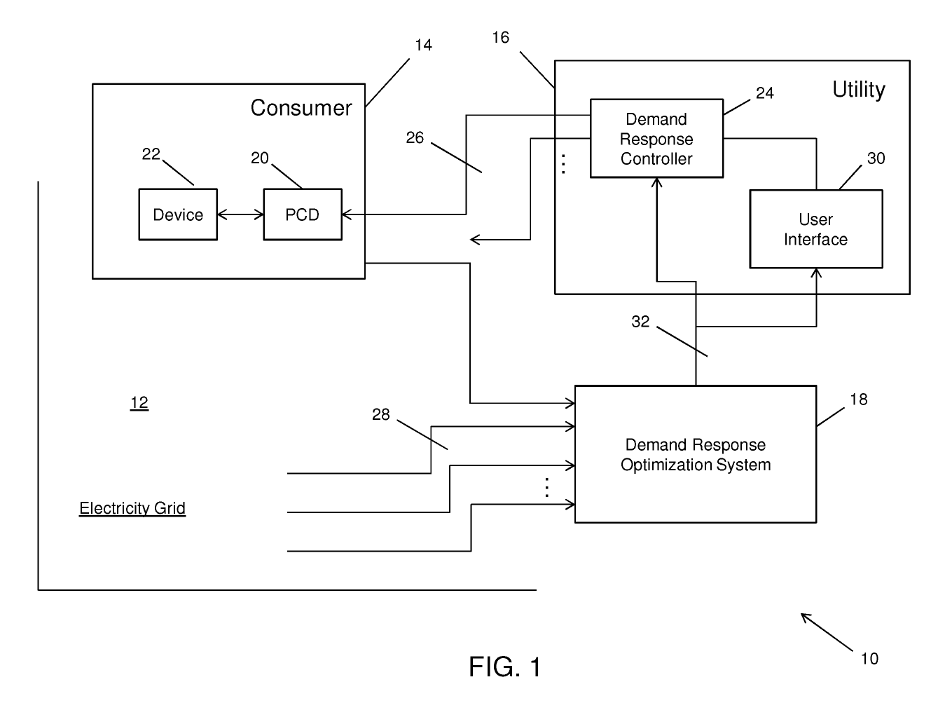

Turning now to the figures, FIG. 1 illustrates a DR system 10 for an example electricity grid 12. For ease of illustration, the electricity grid 12 is shown with a single consumer 14 that is serviced by a utility 16, however, it can be appreciated that other consumers 14 would likely be included in the electricity grid 12. Moreover, it can be appreciated that various items in the system 10 are omitted from FIG. 1 for clarity, including power lines, electrical components and other equipment that would be utilized in order to provide electrical power to the consumer 14.

In the example shown in FIG. 1, the consumer 14 includes one or more power control devices (PCD) 20 which can alter power consumption of a device 22, e.g., by shutting off or reducing power to the device 22. The PCD 20 is controlled by a DR controller 24, which in this example is operated by the utility 16 via a communication connection 26. It can be appreciated that the communication connection 26 can include any suitable medium, such as a wired or wireless network connection, data-over-power, etc. As illustrated in FIG. 1, the DR controller 24 may be connectable to multiple consumers 14 within the electricity grid 12.

In order to optimize usage of the demand response controller 24, a DR optimization system 18 is used. In the configuration shown in FIG. 1, the DR optimization system 18 is operable to receive data from the electricity grid 12 from various sources (including the consumer 14 in this example), via one or more communication connections 28. The DR optimization system 18 can utilize gathered or supplied data to perform optimization analytics in order to determine suitable candidates to participate in a DR program. For example, the data gathered by or supplied to the DR optimization system 18 can be used to determine that the consumer 14 shown in FIG. 1 has a particular pattern of high usage for the device 22 and is therefore an optimal candidate to implement DR on that device 22 during particular periods of time.

The utility 30 may include a user interface 30 to allow administrative users to operate the DR controller 24 and to receive analytics results and performance assessments from the DR optimization system 18 via a suitable data communication connection 32, e.g., the Internet or a cellular network. Although the DR optimization system 18 is shown as being separate from the utility 16 in FIG. 1, it can be appreciated that the utility 16 can also implement or otherwise incorporate the DR optimization system 18 into its own systems. For example, the DR controller 24 may be programmed to include the functionality of the DR optimization system 18. Similarly, the user interface 30 may be provided by the same application as the DR controller 24 and DR optimization system 18. As such, the particular configuration shown in FIG. 1 is for illustrative purposes only.

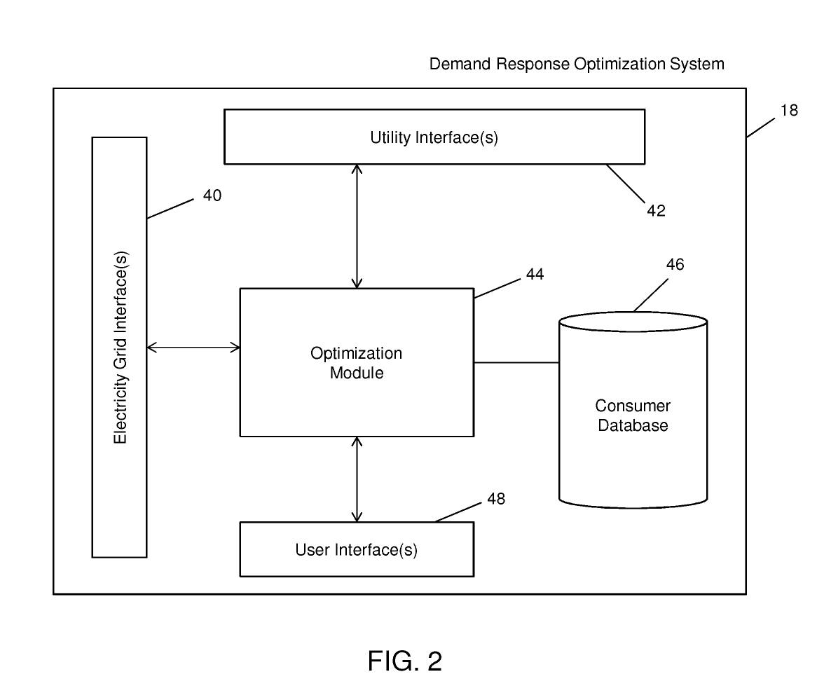

For the configuration shown in FIG. 1, the DR optimization system 18 may be configured as shown in FIG. 2. In FIG. 2, the DR optimization system 18 includes one or more interfaces 40 that enable an optimization module 44 to communicate with the electricity grid 12 for obtaining usage and other data associated with the consumers 14, and includes one or more interfaces 42 that enable the optimization module 44 to communicate with the utility 16. The optimization module 44 includes or otherwise has access to a consumer database 46 for storing consumer-related data used by the optimization module 44 in performing optimization analytics and performance measurements. As illustrated in FIG. 2, the DR optimization system 18 may also include one or more user interfaces 48 to enable a user to control operation of and obtain information/results from the optimization module 44, access and/or populate the consumer database 46, etc.

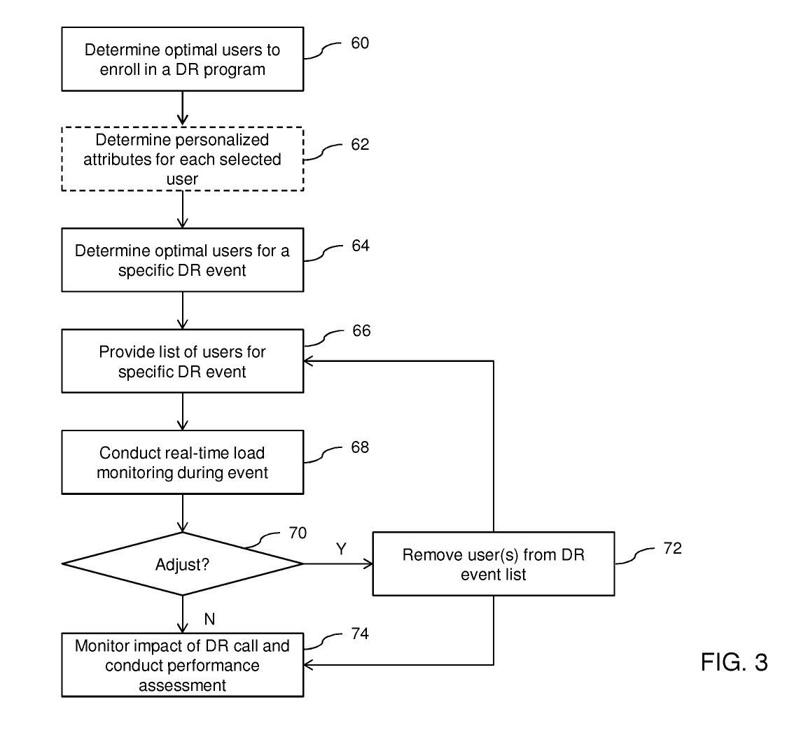

The optimization module 44 enables the DR optimization system 18 to operate with the DR controller 24 to implement, monitor, and assess a DR program for the utility 16. FIG. 3 illustrates operations that may be performed by the DR optimization system 18 in such a role. At 60, the optimization module 44 utilizes data associated with one or more consumers 14 to determine optimal users to enroll in a DR program. This can be based on a variety of statistical and analytic methods which derive the historical impact of each user on peak times. It has been found that past high consumers are generally future high consumers. The benefit of performing such analytics is that it can lower installation and incentive costs because fewer subscribers are needed for the same impact.

At 62, a similar analysis can optionally be performed to determine personalized attributes for each user that has been selected in 60. The personalized attributes for each user can include, for example, the user's projected ecological impact, the user's monetary gain from the program and the user's current peak contribution compared to other households, to name a few. Such metrics can be used by utility for: incentivising high demand users to enrol in DR programs, operational decisions such as user selection, to define potential value of each individual customer for cost-benefit analysis or to define customized incentive offerings, and to enhance marketing and enrolment efforts by providing users with personalized information. This can lower marketing costs for the utility.

At 64, the optimization module 44 determines the optimal users for a specific DR event. The DR analytics utilized by the optimization module 44 and described in greater detail below can determine which DR participants are best suited to be included in a specific DR event, based on the time of the event, a user's historic behavior, utility parameters such as the number of permitted DR “calls” per user, the cost of the call for each user, numerous external factors such as weather and season, etc. It has been found that choosing to include the best DR users for any event reduces ongoing incentive costs while maximizing DR event impact and increasing the reliability of the DR outcome.

At 66, a list of optimal users for the specific event can be provided to the utility 16 for use in operating the DR controller 24. During the event, the optimization module 44 can be used for conducting real-time load monitoring at 68. For example, at the time of the event, the DR analytics can take advantage of real-time consumption data (e.g., from smart meters or alternative electricity consumption sensors) to identify whether a predicted high-impact user is indeed contributing to the peak. If the user is not in a high usage scenario they can be removed from the pool of possible DR users for that call. This lowers costs for utilities by not having to reward users with marginal impact. As such, the monitoring performed at 68 can be used to determine at 70 whether or not the list of DR users should be adjusted. If so, a user can be removed from the DR list for that event at 72, e.g., to modify future DR events with that list of optimal users.

Whether or not the list of optimal users is adjusted, the optimization module 44 can proceed to monitor the impact of the DR call and conduct a performance assessment at 74. The DR analytics therefore also helps to determine the impact of the DR call on the entire grid, as well as on each individual appliance, by identifying whether the targeted appliance has successfully responded to the DR call based on the reduction on its consumption. This can verify that the load control device is functioning and the DR event has been successful. Identifying non-functioning DR devices can also reduce utility costs and increase impact and reliability of DR events.

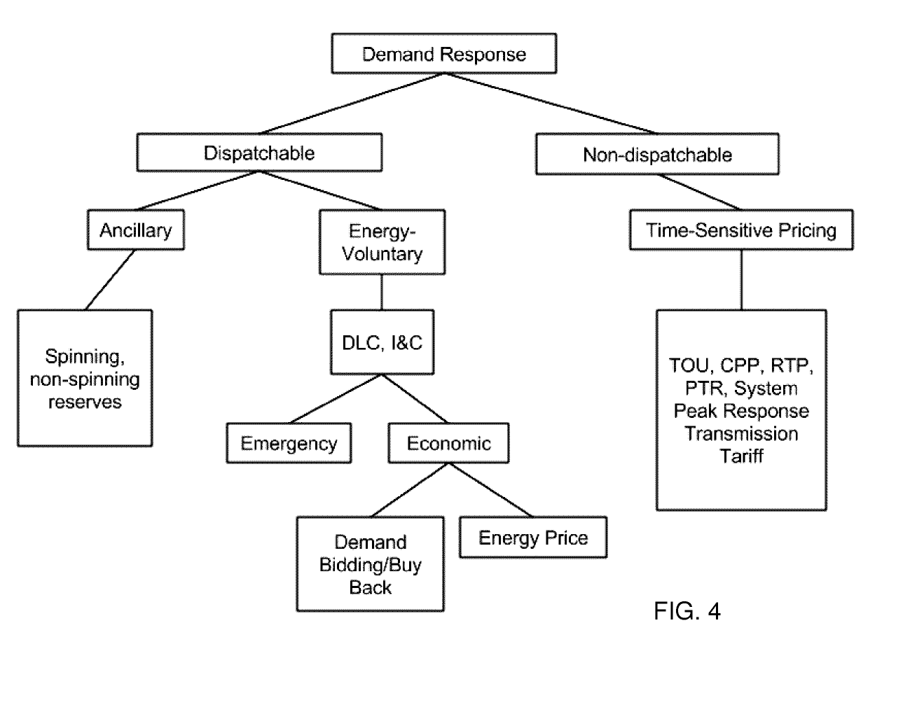

As discussed above, various types of DR exist and should be considered. There are typically two categories of DR, dispatchable and nondispatchable as shown graphically in FIG. 4. Dispatchable DR may be considered active whereas nondispatchable DR may be considered passive.

Nondispatchable DR includes time-sensitive pricing, such as time of use (TOU) and critical peak pricing (CPP), which are intended to discourage use during particular times. For large utilities real time pricing (RTP) can be used. Other examples include Peak Time Rebates (PTR) in which consumers are offered rebates to reduce consumption during peak events, as well as System Peak Response Transmission Tariff that offers to reduce transmission charges to customers who reduce load during peaks.

Dispatchable DR may include ancillary services and energy-voluntary types. Ancillary services DR includes a number of specialty services that are needed to ensure the secure operation of the transmission grid, e.g., for spinning and non-spinning reserves. They have traditionally been provided by generators but other devices have become more common in recent years. Ancillary services DR can involve starting onsite generation which may or may not be connected in parallel with the grid.

Energy-voluntary dispatchable DR include DLC and interruptible and curtailable loads as discussed above. A subclass of dispatchable DR is emergency demand response, which is employed during critical times to avoid demand exceeding supply which therefore threatens the stability of the grid. The other branch of DR is motivated by the utilities desire to operate economically. For example, as power grids are becoming more interconnected, energy trading has become a profitable venture for utilities. Emergency and economic demand response are generally implemented by the installation of power cut off devices to certain loads. At critical times the power supply to these loads would be cut or reduced to lower the total demand to the grid, referred to a load shedding as discussed above.

As noted above, it has been found that because the installation of demand response equipment and incentives for subscribers is typically expensive to the utility, savings can be made from targeting specific users for demand response programs. It has been found through experimental simulations utilizing the optimization module 44, using historic data, that a reduction in the number of participants required to achieve a predefined demand by more than 40% is achievable. Further detail regarding a study related to such findings is provided below.

Exemplary details of an analytics process that can be operated by the optimization module 44 will now be described.

The analytics in this example are performed in order to investigate a series of well-defined variables that strongly correlate with the usage of a DR device such as the PCD 20. By appropriately weighting these variables, the optimization module 44 can be used to derive an understanding of each user and compare their consumption behavior (and impact) to others. For example, user rankings can be created based on the derived variables to represent the expected relative priority with which their load should be targeted in order to optimally reduce the total grid power consumption while making the fewest number of DR requests.

One variable to estimate for a given appliance load is the appliance's consumption over time, given an aggregate consumption signal from sensors such as smart meters. Estimating load consumption based on aggregate data provides an alternative to hardware-based monitoring systems that require hardware and installation labour costs.

Other variables include the total appliance consumption over a time period, the diversification profile (i.e., the average daily consumption pattern of an appliance for one or more users), the diversification factor (i.e., the ratio of users with a given appliance expected to use it at a peak time), the peak coincidence factor (i.e., the probability of a user's appliance being on at a peak time), the utilization factor (e.g., the ratio of the time the appliance is used), the appliance size (i.e., nameplate or effective maximum load size of an appliance), etc.

Profile histograms can be useful in such analyses. A profile histogram is a histogram where the horizontal axis is divided into several ranges as with a normal histogram. The difference is that instead of the vertical axis showing the number of entries for that variable in each range it shows the mean value of another variable for all the values in the range. In this way, a profile histogram is a representation of two variables and their correlation. It can be extracted from a scatter plot by projecting one dimension into the mean.

The above information may then be used for performing a user analysis, profiling and comparisons, as well as to perform optimizations on utility programs such as DR and DLC, similar to the applications discussed earlier.

The following example relates to the direct load control of air conditioning units in the southern hemisphere. It has been found that the following methodology can result in a 40% reduction of the number of necessary DR participants to reach the desired load reduction.

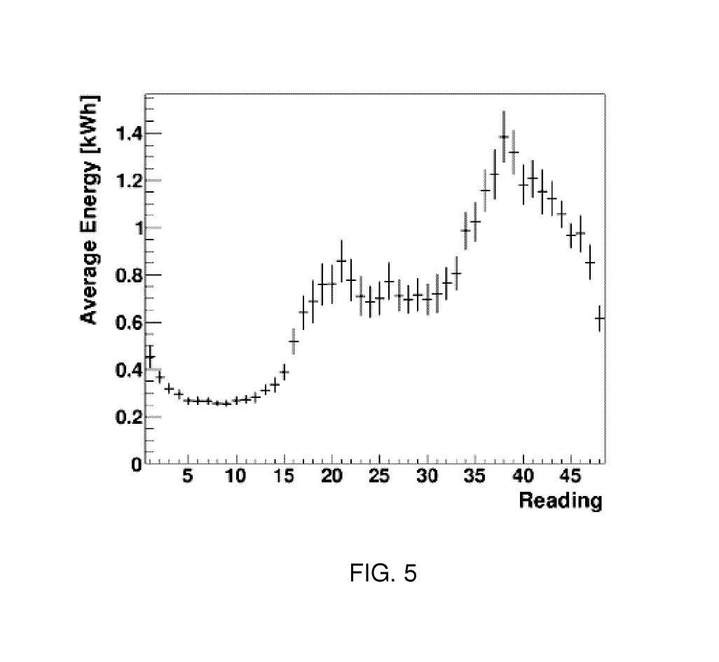

As mentioned above, it is typically important to estimate a daily load profile for the targeted appliance, which in this case is an AC. In this scenario, the AC daily load profile is derived based on days with AC activity versus days without. The assumption here is that AC use is seasonal. Thus days in the spring (250^{th}-310^{th} day of the year) are assumed to see inactive AC use. An example for a specific user is shown in FIG. 5. In this case readings were taken every half hour resulting in 48 measurements per day.

We then model the user's AC consumption days using the premise that AC's are active for days over 30 degrees Celsius. Similar profile plots can be made averaging over these hot days. This gives an “Aggregate Profile for Active Demand Response Devices” (APADRD) and an “Aggregate Profile for Inactive Demand Response Devices” (APIDRD). The AC usage profile is then defined as the difference of the mean derived in the APADRD and APIDRD plots.

It may be noted that one would expect different usage patterns for different days of the week. The above calculations were performed separately for weekends and weekdays. The daily profiles were then used to calculate the user's peak coincidence factor between the APIDRD and the reading values for hot days. The coincidence factor may be defined as the fraction of days for which there was a statistically significant number of readings higher than the APIDRD plot in its peak period taking into account the statistical and systematic variations of the analysis. The utilization factor was also calculated for each user, defined as the number of readings that are significantly above the APIDRD, divided by the total number of readings in a day. The overall grid diversification factor and the effective size of each individual user's AC load were also estimated, among other factors. Several other variables were investigated to find the optimal ranking criteria. These included:
The mean of the vertical axis in the AC usage profile plot over all 48 readings
The percent of the integral the of the AC usage profile in 6 pm-9 pm
Variables which are not intended to directly measure the target appliance's usage were also explored. These included:
Maximum Aggregate Energy Reading value in the time period of the data
The Maximum reading on the day when the total grid energy demand from the selected users was highest.
The previous value divided by the average of that value over all users.
The maximum difference between a reading and the previous

Finally, in this example the objective was to use the above derived variables to create user rankings for a DR targeting application. The ranking was created as a function of the estimated AC size for each user, and the peak coincidence factor representing how likely a user is to utilize their AC during a peak hour. As illustrated by these results, the ranking can accurately reject the likely impact of each user's AC consumption on the grid. Thus, by targeting users with higher impact, the total number of DR participants needed to achieve a desired reduction can be reduced.

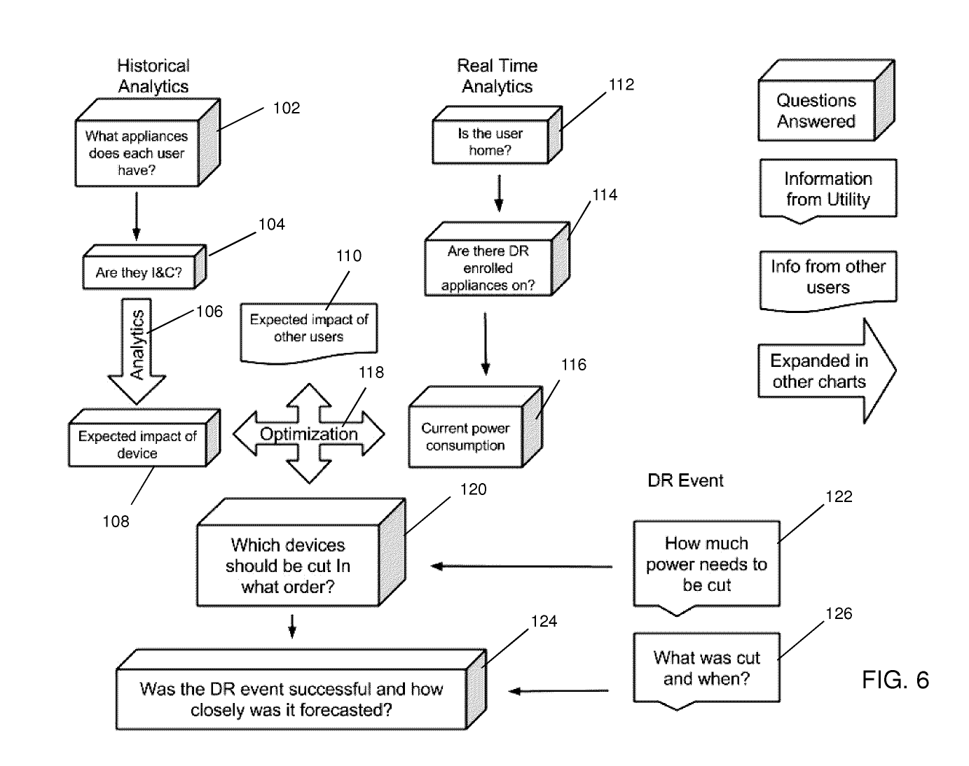

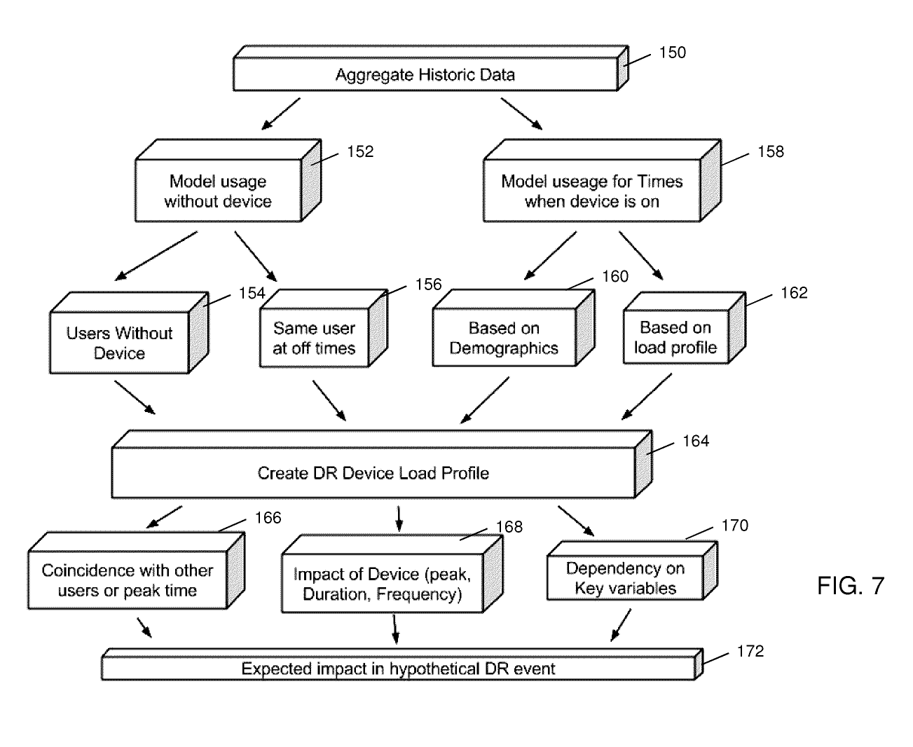

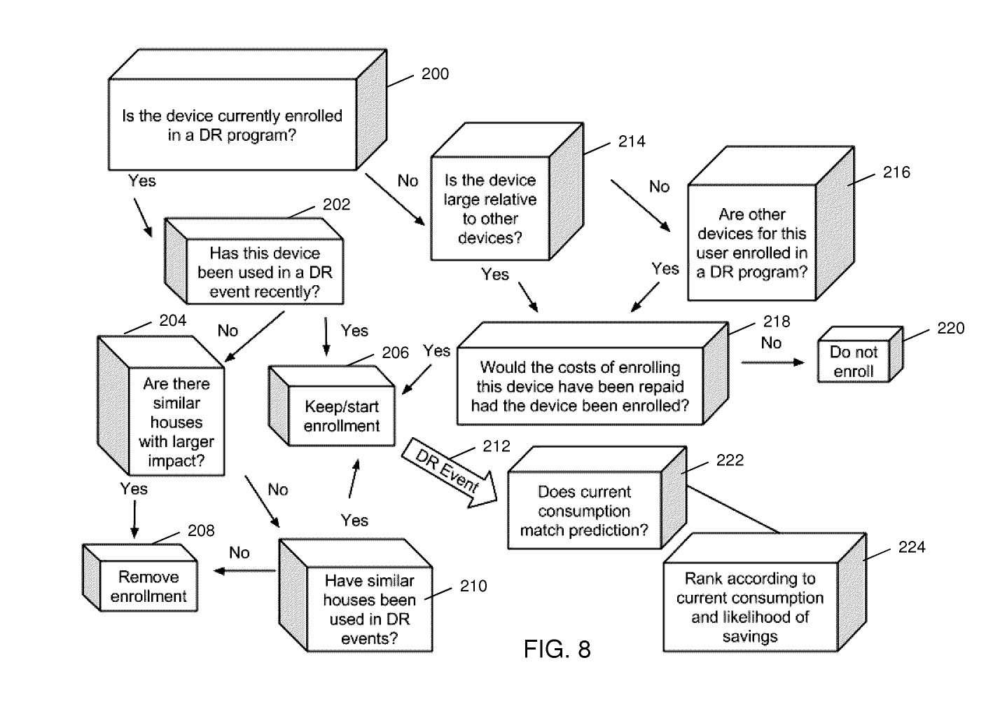

FIGS. 6 to 8 are a series of flow charts to illustrate an example process for performing analytics to optimize a DR program. FIG. 6 provides an overview, and FIGS. 7 and 8 provide further detail for particular operations illustrated in FIG. 6. The analytics shown in FIG. 7 describes the process by which a metric for the ranking of users can be derived, and FIG. 8 illustrates an optimization between the varying branches of FIG. 6.

Turning now to FIG. 6, an optimization performed at 118 utilizes several data components. For example, the expected impact of a device determined at 108, the expected impact of other users determined at 110, and the current power consumption determined at 116 can be used to perform the optimization in order to determine which devices should be “cut” and in what order at 120.

The expected impact of a device at 108 is determined in this example based on historical analytics, such as determining at 102, what appliances each potential consumer 14 has, and determining at 104 whether these appliances are interruptible and curtailable. Analytics may then be performed at 106 in order to arrive at the expected impact of that particular device. For example, once a curtailable appliance is identified, a predictive load model can be create by evaluating the appliance's historical usage behavior. This is estimated by disaggregating historical smart meter data. The predictive load model is then used to estimate how much power the appliance will draw in an upcoming peak event, and decide whether a DR event needs to be triggered on the given appliance.

The expected impact of other users determined at 110 is the predicted load of other users in a given period, and the aggregate size of the potential curtailable load that can be accomplished by engaging them in a DR event. These parameters help determine if a peak period requires a DR event, and which users are should be enrolled into that event based on their curtailment impact.

The current power consumption determined at 116 is in this example based on real time analytics. For example, as shown in FIG. 6, the optimization module 44 may determine at 112 whether or not the user is home, how much power their load is consuming, how likely they are to interact with or need a given appliance, and determine at 114 whether or not there are DR-enrolled appliances in that home.

The historical and real time analytics can therefore be considered by the optimization module 44 to determine which devices and thus which consumers 14 would be best included in the DR program. This can also consider at 122 how much power needs to be cut in order to have a successful DR event. During and after the DR event, the electricity grid 12 can be monitored and assessed to determine at 124 whether or not the DR event was successful and how closely it was forecasted based on the analytics performed prior to the event. In such an assessment, the optimization module 44 may consider at 126, other information such as what appliances were cut and when.

FIG. 7 illustrates further detail in determining the expected impact of a device in a hypothetical DR event, e.g., for implementing 108 in FIG. 6. At 150 an aggregate of historical data is obtained and modelling is performed at 152 to model usage without the device being considered, and at 158 to model usage for when the device is being used.

Modeling usage without the device at 152 may include evaluating users without the device at 154 and evaluating the same user when he/she is not using the device at 156. For example, to model usage by an AC, historic data from other homes that do not have AC can be contrasted to those who do (154). As well, the summer usage data by homes with AC can be contrasted to their winter season to evaluate the impact of the AC load (156). The differences in such patterns can assist in determining what the AC usage actually looks like, separated from the rest of the energy used in the home. Modeling usage for times when the device is on may be based on demographics as determined at 160 and based on a load profile at 162. For example, knowing the number of users in the home, their age group, or their income, could help estimate their usage behavior (e.g., sleeping hours, etc.). The outcomes of the models are used at 164 to create a DR device load profile. The load profile is then used at 166 to determine any coincidences with other users or peak times (e.g., how likely is the user to turn on the AC during a peak hour), at 168 to determine the impact of the device such as peak, duration, and frequency (e.g., how often is the AC used, how big the AC load is, etc.), and at 170 to determine any dependencies on key variables (e.g., how quickly does the user respond to changes in outside temperature by adjusting the AC, how often do they use their AC during work days or holidays). These outcomes of the load profile analysis are used to compute an expected impact for the hypothetical DR event at 172.

Turning now to FIG. 8, an example of operations that may be performed in ranking a candidate for a DR event is shown. Ranking can be performed by a utility when they wish to add new users to a DR program (e.g., enrolling by installing hardware in the home) or when the utility wishes to trigger a DR event in a peak hour (e.g., by determining which users to trigger so as to optimize the cost of the event while minimizing the inconvenience to the consumers). The utility can also evaluate rankings to determine if particular consumers should be removed from the program due to a lack of value (to minimize ongoing incentive costs) or to reach out to consumers who are not responding to the DR triggers as expected (e.g., if the DR hardware has been compromised or tampered with). At 200 the optimization module 44 determines if the device being ranked is currently enrolled in a DR program. If so, it determines at 202 whether the device has been used in a recent DR event. If the device has been used recently, the device is designated as one to keep in or start in an enrollment program. If not, the optimization module 44 determines at 204 whether or not there are similar houses with a larger impact. If so, the device is removed from the enrollment at 208. If not, the optimization module 44 determines at 210 whether or not similar houses have been used in DR events. If not, the device is removed from enrollment at 208. If so, the device is enrolled at 206.

If the device is not currently enrolled in a DR program, the optimization module 44 determines at 214 whether or not the device is a large consumer of electricity relative to other devices. If so, the optimization module 44 determines at 218 whether or not the costs of enrolling the device would have been repaid had the device been enrolled. This is to say whether the value of the potential load shed by the user exceeds the cost of enrolling the user in the DR program (e.g., hardware cost, installation cost, marketing cost). If not, the device is not enrolled at 220. If so, the device is enrolled at 206. If the device is not a large consumer of electricity, the optimization module 44 determines at 216 whether or not other devices for the same consumer 14 are enrolled in a DR program. If so, the determination at 218 can be made.

For those devices enrolled at 206, the associated DR event occurs at 212 and the optimization module 44 monitors the outcome of the DR event to determine at 222 whether or not the current consumption matches the prediction, and by how much, in order to rank the device at 224 according to the current consumption and likelihood of savings.

It can be appreciated that the analytics can be performed at various stages, e.g., when attempting to find and enroll users (i.e. to determine which are best suited, who has large appliances used during peak times, etc.), when an event needs to occur (e.g. to determine which users should be triggered to optimize cost and convenience), during the event to ensure the necessary load shedding is accomplished (and if not, acting to shed more load before an issue such as a brown out occurs), or after the event to evaluate how well the event was performed in terms of load reduction (e.g., such that incentives are not paid to consumers that did not deliver a reduction, remove such consumers, remove or fix equipment if a problem is found, learn more about consumers and their behavior for subsequent events, etc.)

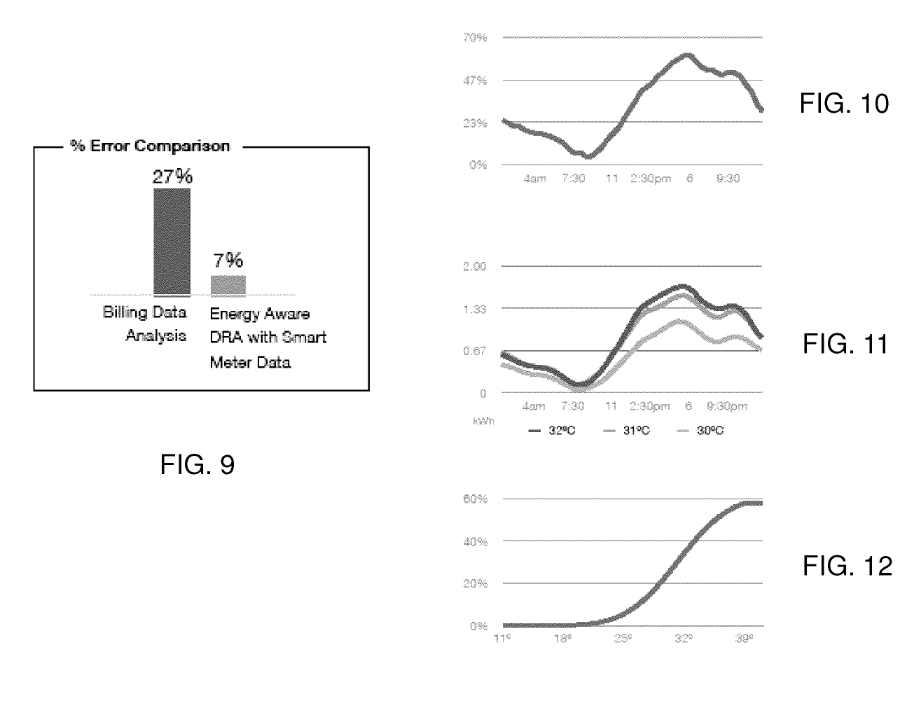

Turning now to FIGS. 9 to 16, an example of analytics performed on a set of data for a DR program. The following example was performed using smart metering data, which was leveraged to run a more effective DR program. The analytics performed can be used to evaluate the value of an anticipated DR program based on the potential for household appliances that exist in the market, in order to shed load. The analytics was used in this example to convert smart meter data into actionable intelligence to forecast demand and increase the effectiveness of the DR program in order to assist a utility 16 in decreasing the acquisition cost per kW at peak and minimize customer disruption.

This example evaluates air conditioning (AC) loads using thirty minute interval data from 227 homes evaluated over a one year period. A training data set was used that included 182 homes to adapt the DR analytics models. The 45 remaining households were in a blind dataset, in which it was determined which have AC units. Table 1 below summarizes the experiment for an AC identification and analysis.

TABLE 1
Experiment Summary
for Air Conditioner Identification and Analysis

| Location | Sydney |
|---|---|
| Total # of Homes (Training and Blind) | 227 |
| Blind Data | 45 |
| Homes with ACs (from blind dataset) | 29 (64%) |
| ACs 3 kW or higher (from total dataset) | 73 (32% |
| Detection accuracy | 93.3% |
| Data intervals | 30 minutes |
| Time Period | Date X to Date Y |

In previous studies, the presence of ACs was typically determined using seasonal billing data. As shown in FIG. 9, it has been found that the prior method can achieve an accuracy of 73% against true data compared to the methodology herein described which was found in this example to achieve a 93% accuracy therefore reducing the identification error by 4 times.

Using the smart meter data, the DR analytics performed by the optimization module 44 can estimate and predict load demand from individual appliances, how the load will change with respect to time and temperature, an appliance diversification factor, and various other variables that can be used for network strategic planning. These analyses can then be used to assist in DR program design and to assist in quantifying load shed opportunities within selected constraints.

Referring to Table 2 below in conjunction with FIG. 10, an AC diversification (DVF) can be used to estimate the proportion of AC loads in a market that are expected to be used at the same time. In the study conducted, approximately 60% of ACs were estimated to operate during peak hours on days above 30° C. (i.e. 86° F.). This can be used to perform a trend analysis, such as predicting future peak demands based on AC growth in a market. DVF can also assist in quantifying the estimated demand reduction opportunities of a potential AC control event prior to running the DR program.

TABLE 2
Peak Diversification Factor (DVF)-
AC Peak Demand Potential

| | Hour | ° C. | DVF % |
|---|---|---|---|
| Peak Demand-AC | 5:30 pm | >30 | 60 |

Referring to Table 3 below in conjunction with FIG. 11, an AC diversification analysis was also conducted, which represents the predicted energy demand of ACs against time and temperature. The graph in FIG. 11 shows the size of AC load demand increase as temperature rises to assist in estimating the size of the contribution to a specific appliance to the overall demand.

TABLE 3
Daily Profile-AC Diversification Curve Over a Day

| | 30° | 31° | 32° |
|---|---|---|---|
| Avg. peak demand (kWh) | 1.13 | 1.53 | 1.67 |
| Time of peak demand | 4:30 pm | 5:00 pm | 5:00 pm |

Referring to Table 4 below in conjunction with FIG. 12, it has been found that AC users typically respond differently to changes in outside temperature. The DR analytics performed by the optimization module 44 can be used to estimate the percentage of ACs operating at a given temperature. This can be used to improve grid planning an operations such as optimizing capital expenditure and asset management, contingency, and maintenance planning, etc.

TABLE 4
Temperature Correlation-
AC Load Demand With Respect to ° C.

| | 18° C. | 25° C. | 32° C. | 39° C. |
|---|---|---|---|---|
| AC Demand | 1.4% | 5.6% | 34.3% | 57.7% |

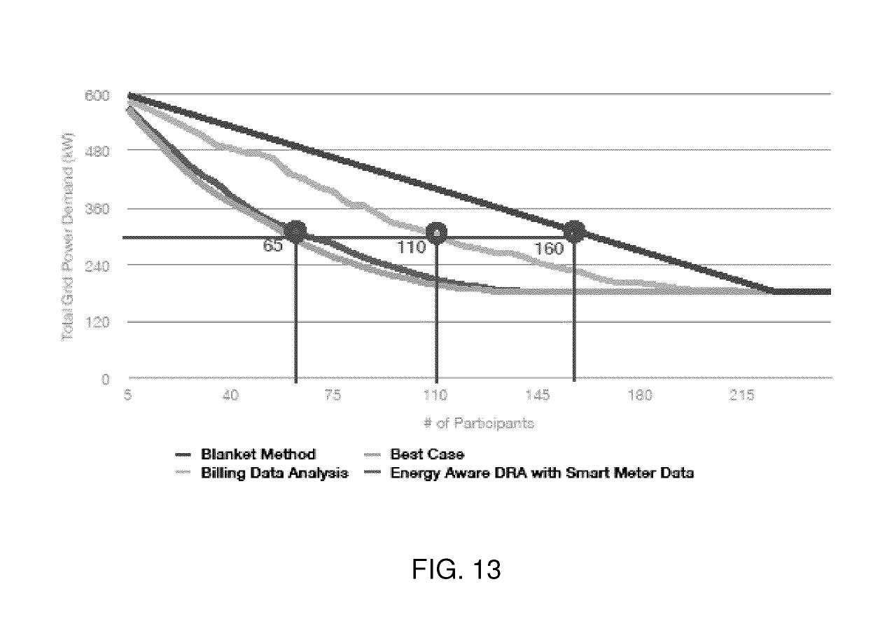

Referring now to FIG. 13, in the present example, it was estimated that without advanced screening of participants in an AC program, up to half of the respondents would likely not have a suitable AC, and of those who do, half would have ACs that are too small to have a cost effective impact. The optimization module's analytics can be used to demonstrate how homes for a specific DR program can be pre-screened for eligibility based on smart meter data, thus reducing cost, reducing disruption, and reducing recruitment time. It has also been found that using such analytics, a utility 16 can identify and target users with highest load shed potential, thus reducing the acquisition cost per kW at peak load and minimize user disruption.

An example of such an improvement is shown in FIG. 13 where performing analytics using smart meter data is much closer to a best case scenario than an analysis based on billing data or a blanket method.

In the example described herein, it was found that a desired load shed could be achieved while requiring only 40% of the number of participants otherwise needed in a blanket marketing program (i.e., presenting all customers with incentives to participate) commonly used in the industry, by removing homes with a minimal impact. Using the optimization module 44, preferred homes can be identified and targeted for DR program enrollment and/or preferred homes can be pre-selected for having a higher load shed capacity for program participation (e.g. users most likely to use larger ACs at peak hours).

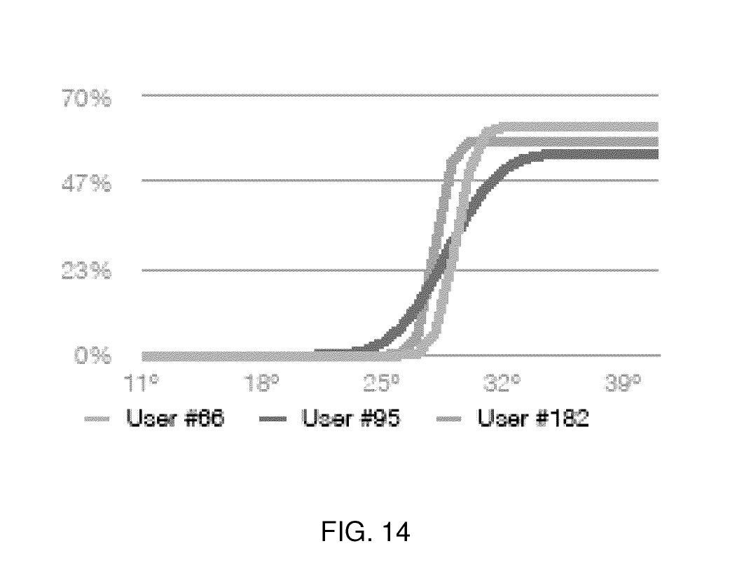

As discussed above, AC users typically respond differently to changes in outside temperature. The graph shown in FIG. 14 illustrates sample individual daily AC usage. The optimization module 44 can be used to identify: 1) the critical temperature at which the user turns on the AC, and 2) the AC control type, such as a programmed thermostat (gradual curve) versus manual control (steep curve). When a DR program involves the replacement of regular thermostats with smart thermostats, the analytics described herein can pre-screen users with existing thermostat-control ACs.

It has also been found that DR events can be optimized by selecting participants based on the likely time and magnitude of their energy demand. In programs in which users are protected against participation in consecutive day events, if critical peaks are expected in consecutive days, the analytics described herein can be used to quantify the load shed opportunity by each user, and optimize the user selection for each day's event to maximize the acquired load shed.

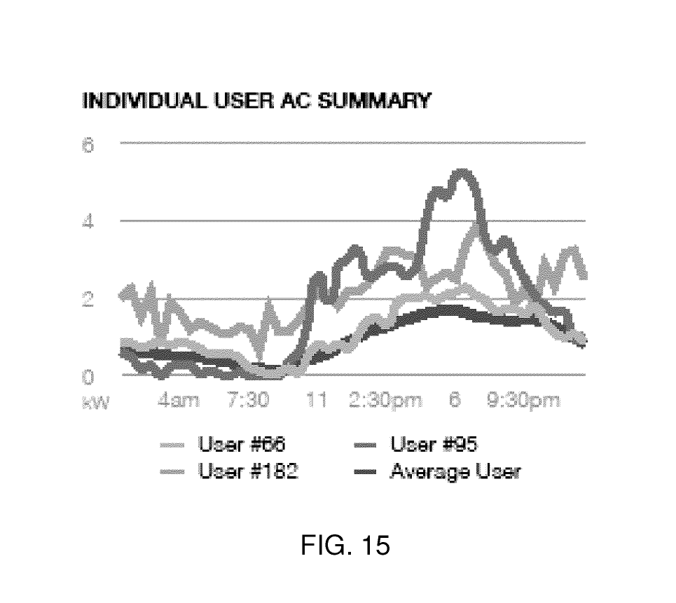

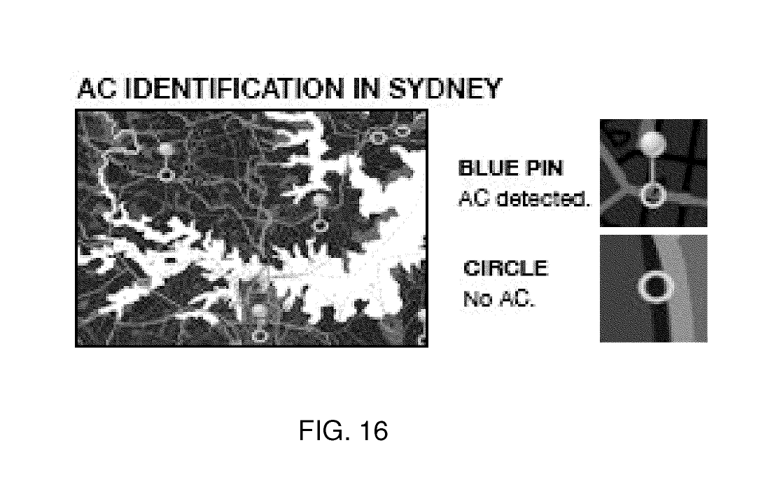

The analytics described herein can also estimate specific information regarding user appliance type, size (kW), and usage behavior. Results of the analysis for three users is shown in the dataset provided in Table 5 below and is illustrated in the graph shown in FIG. 15.

TABLE 5
Individual User Summary

| | USER # | | |
|---|---|---|---|
| | 66 | 95 | 182 |
| AC Size (kW) | 2.9 | 5.2 | 5.5 |
| High-Impact Days | 12 | 14 | 20 |
| Total AC use (kWh) | 650 | 870 | 2050 |
| Daily Use Ratio (>30° C.s) | 32% | 26% | 20% |
| Peak Coincidence Factor | 67% | 50% | 15% |

In Table 5, the AC size refers to the observed full-load capacity of the AC, the high-impact days are the number of days with high AC use in the data period, the total AC use is an estimate of the total kWh within the data period, the daily use ratio refers to the percentage of AC used on days >30° C. within the period, and peak coincidence refers to the percentage of AC use between 6 and 9 pm.

Upon completion of a DR event, the analytics described herein that are used for event optimization can also be used to flag non-participants and to reward those who did participate. Unlike prior DLC programs that do not directly account for appliance level load shed, the analytics described herein can assist in identifying users with failed DLC hardware and can prevent incentives from being provided to users that are enrolled in the DR program but who did not participate in a specific DR event. Such analytics also allows utilities 16 to award different incentive amounts per user based on the amount of load that is shed rather than provide flat-rate incentive amounts, which can encourage greater participation volume.

By measuring the performance of DR participants after each event, the optimization module 44 can be used to improve the ability to monitor and improve existing DR programs, while reducing ongoing incentive costs.

It has also been found that specific appliance disaggregation can determine suitability for a particular DR program and confirm participation. As can be observed from an analysis of the energy demand curves in graphs in FIGS. 14 and 15, Users #95 and 182 have the largest AC units, but #95 has the greatest peak demand fluctuation and can be considered the most ideal candidate of the three for this peak period DR event. The same curve can also be used to confirm whether the user responded to the DR event. A visual representation of homes can also be generated and overlaid on a map as shown in FIG. 16, e.g., based on postal/ZIP code.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 10 or system 18, any component of or related to the system 10 or system 18, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of optimizing a demand response program, the method comprising:
obtaining, by a processor, usage data for each of a plurality of devices, at least some of the devices used b different users at different remises, said data comprising at least one variable;
calculating, by the processor, an impact of each device on a demand response event based at least in part on said variables; and
determining, by the processor, which of the users should be enrolled in the demand response program based on their devices having a higher impact than the devices of the other users; thereby performing an optimization of the demand response program.

2. The method of claim 1, wherein the optimization is performed prior to implementing the demand response program.

3. The method of claim 1, wherein the optimization is performed subsequent to a demand response event associated with the demand response program.

4. The method of claim 3, further comprising adjusting the demand response program for a subsequent demand response event.

5. The method of claim 1, wherein the optimization is performed during a demand response event associated with the demand response program.

6. (canceled)

7. The method of claim 1, further comprising determining personalized attributes for each user, wherein determining which of the users should be enrolled is based on said personalized attributes.

8. The method of claim 6, further comprising determining a set of optimal users for a specific demand response event, and providing the set as an output for use in implementing the demand response program.

9. The method of one claim 8, further comprising:
performing load monitoring during the specific demand response event; and
performing, based on said monitoring, at least on of:
adjusting the set of optimal users for a subsequent demand response event; and
conducting a performance assessment of the specific demand response event.

10. The method of claim 9, wherein performing the optimization comprises utilizing at least one of:
historical analytics;
real-time analytics;
an expected impact of each device.

11. The method of claim 10, wherein utilizing the historical analytics comprises:
determining if one of said devices is interruptible or curtailable; and
determining an expected impact of said interruptible or curtailable device.

12. The method of claim 10, wherein utilizing the real time analytics comprises determining current power consumption of the devices.

13. The method of claim 1, further comprising determining which of the plurality of target devices are to be controlled, and in what order.

14. The method of claim 1, further comprising modeling at least one of:
usage without one of the devices; and
usage for times when said one device is on.

15. The method of claim 14, further comprising:
creating a demand response device load profile for said one device; and
using said load profile to determine an expected impact of said one device in a hypothetical demand response event.

16. The method of claim 15, wherein the load profile is indicative of at least one of:
whether said load profile coincides with load profiles of devices used by other users;
whether said load profile coincides with peak times;
an impact of said one target device in the hypothetical demand response event; and
dependencies on external factors.

17. The method of claim 1, further comprising:
ranking the devices; and
selecting, based on the ranking, at least some of the devices for a demand response event associated with the demand response program.

18. The method of dam 17, wherein the ranking takes into consideration at least one of:
usage of the devices in other demand response events associated with the demand response program;
similarities between premises having the devices; and
a cost of enrolling a consumer into the demand response program.

19. The method of claim 1, further comprising at least one of:
simulating the demand response program to assess its viability;
selecting a demand response program type and an associated implementation strategy; and
providing feedback to users and utilities associated with demand response performance.

20. A computer readable storage medium comprising computer executable instructions, which when executed by a processor, cause a demand response optimization system to:
obtain usage data for each of a plurality of devices at least some of the devices used by different users at different premises, said data comprising at least one variable;
calculate an impact of each device on a demand response event based at least in part on said variables; and
determine which of the users should be enrolled in the demand response program based on their devices having a higher impact than the devices of the other users;
thereby performing an optimization of the demand response program.

21. A system comprising a processor and memory, the memory comprising computer executable instructions which, when executed by the processor, cause the processor to:
obtain usage data for each of a plurality of devices at least some of the devices used by different users at different premises, said data comprising at least one variable;
calculate an impact of each device on a demand response event based at least in part on said variables; and
determine which of the users should be enrolled in the demand response program based on their devices having a higher impact than the device of the other users;
thereby performing an optimization of the demand response program.
